(19) United States
(12) Patent Application Publication
(10) Pub. No.: US 2023/0292952 A1
(43) Pub. Date: Sep. 21, 2023

(54) FOOD PROCESSOR

(71) Applicant: UNI-SPLENDOR CORPORATION, Tainan City (TW)

(72) Inventor: YU-YUAN LIN, TAINAN CITY (TW)

(21) Appl. No.: 17/696,482

(22) Filed: Mar. 16, 2022

(51) Int. Cl. A47J 31/44; A47J 43/07; A47J 42/38; A23G 9/22

(52) U.S. Cl. CPC A47J 31/4403; A47J 43/07; A47J 42/38; A23G 9/22

(57) ABSTRACT

A food processor is revealed. A food processing unit is disposed between two support units of a machine body and connected to the support units by a lifting unit. The food processing unit is dropped down into the machine body while the food processor is not in use. Thus a volume of the food processor is significantly reduced and both packing and transportation costs are further saved efficiently. The lifting unit is provided with a guiding slot formed on the support unit while the food processing unit includes a guiding block inserted through the guiding slot correspondingly. The lifting unit further includes an operation bar locked and connected with the guiding block. Thereby the food processing unit is moved and positioned vertically by such simple and easy design and the production cost of the food processor is further reduced.

### BACKGROUND OF THE INVENTION

### Field of the Invention

The present invention relates to an electrical appliance, especially to a food processor.

### Description of Related Art

Owing to wide spread of covid-19, people are choosing online shopping instead of going to a variety of stores. This has tremendous impact on logistics and supply chain and transportation cost is increasing. The transportation cost is directly proportional to the volume of goods. Thus the key point of research and development of products available now is reduction of packing volume in order to reduce transportation cost.

Refer to Taiwanese Pat. Pub. No. I357809B “coffee machine with height adjustable tray” and Chinese Pat. Pub. No. CN205994297U “a kind of smart coffee machine”, the height of the tray on which coffee cups are put is adjustable so that users can make and take a cup of coffee conveniently. However, only the tray of the coffee machine is adjustable and the total height of the whole coffee machine is still the same. The transportation cost remains high because the volume of the whole coffee machine is not reduced.

Some people in the business have developed coffee machines with adjustable heights. Refer to Chinese Pat. Pub. No. CN103622557B “drip coffee maker” and Chinese Pat. Pub. No. CN110236393A “folding coffee machine”, theses coffee machines include a funnel assembly and a base connected by a water tank. The volume of the coffee machine is reduced by the water tank folded toward and stored in the base. However, an area allowing folding and extending is located at the water tank so that leak-tightness reinforcement member is required to prevent damages caused by water leakage. Thereby not only the folding and extending structure is more complicated, the production cost is also increased. Thus there is room for improvement and there is a need to provide a novel design for height adjustment of the machine.

### SUMMARY OF THE INVENTION

Therefore, it is a primary object of the present invention to provide a food processor which is having simple structure and compact design with a reduced volume while not in use for reduction of transportation cost and storage space.

In order to achieve the above object, a food processor according to the present invention mainly includes a food processing unit disposed between two support units of a machine body and connected to the support units by a lifting unit. The food processing unit is moved down into the machine body while the food processor is not in use. Thus a volume of the food processor is dramatically decreased and both packing and transportation costs are further saved efficiently. The lifting unit is provided with a guiding slot formed on the support unit while the food processing unit includes a guiding block inserted through the guiding slot correspondingly. The lifting unit further includes an operation bar locked and connected with the guiding block. Thereby the food processing unit is moved and positioned vertically by such simple and easy design and the production cost of the food processor is further reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is an exploded view of an embodiment according to the present invention;

FIG. 3 is a partial enlarged exploded view of an embodiment according to the present invention;

FIG. 4 is a partial enlarged sectional view of an embodiment according to the present invention;

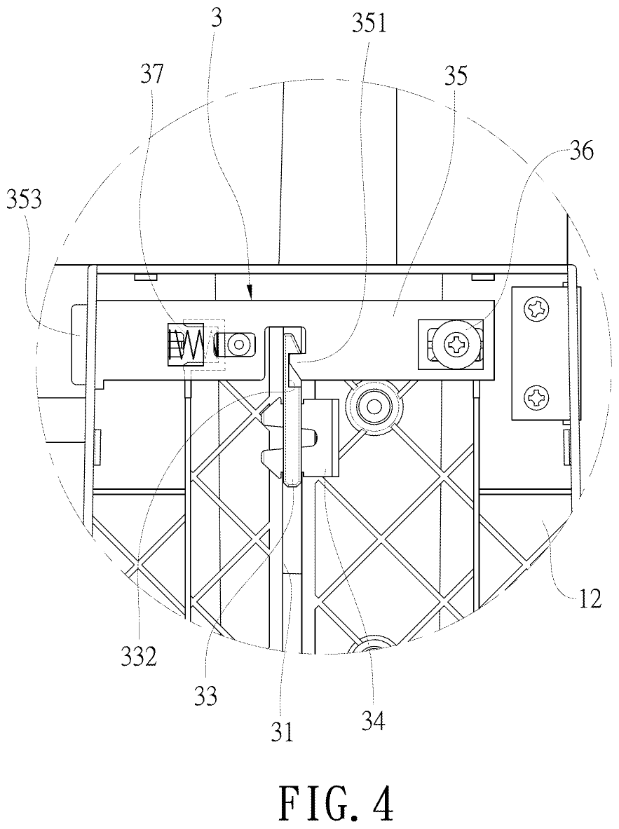

FIG. 5 is a partial enlarged sectional view of an embodiment in a folded state according to the present invention;

FIG. 6 is a perspective view of an embodiment folded in a folded state according to the present invention.

### DETAILED DESCRIPTION OF THE PREFERRED EMBODIMENT

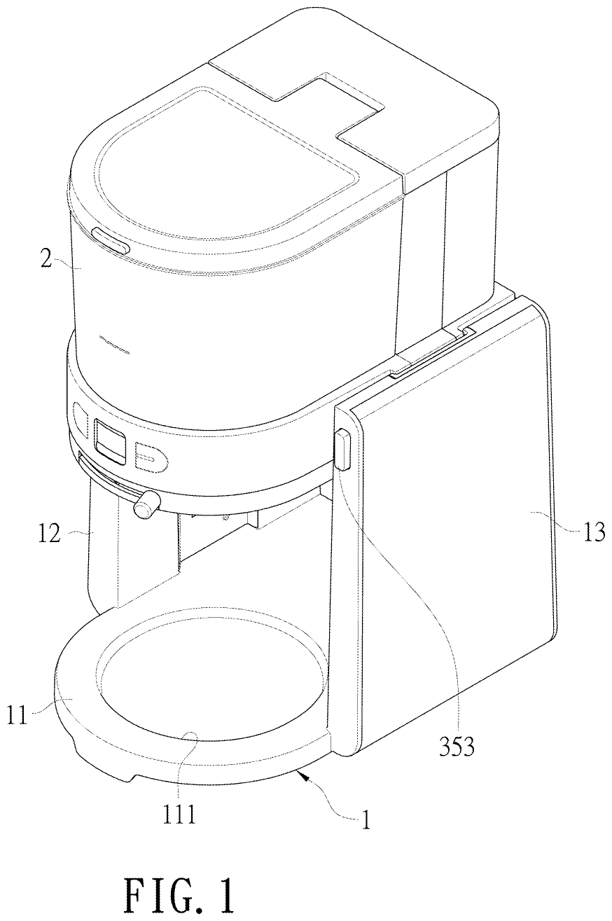

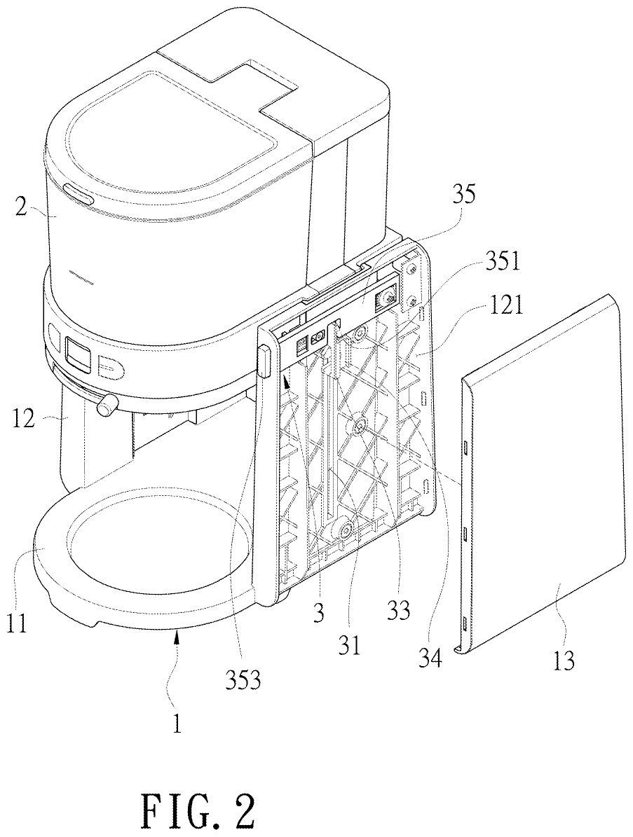

Refer to FIG. 1 and FIG. 2, a food processor according to the present invention includes a machine body 1, a food processing unit 2, and a lifting unit 3.

The machine body 1 consists of a base 11 provided with a recessed container positioning portion 111, two support units 12 connected to a lift side and a right side of the base 11 correspondingly and each of the support units 12 is having a cavity 121, and two side covers 13 each of which is used for covering the cavity 121 of the respective support units 12.

The food processing unit 2 is mounted between the two support units 12 of the machine body 1 and located above the base 11 of the machine body 1. The food processing unit 2 can be a food grinder, a coffee maker, a blender for crushing fruit to make juice, or a shaved ice machine. The food grinder is used for grinding coffee beans, soybeans, and nuts (such as walnuts).

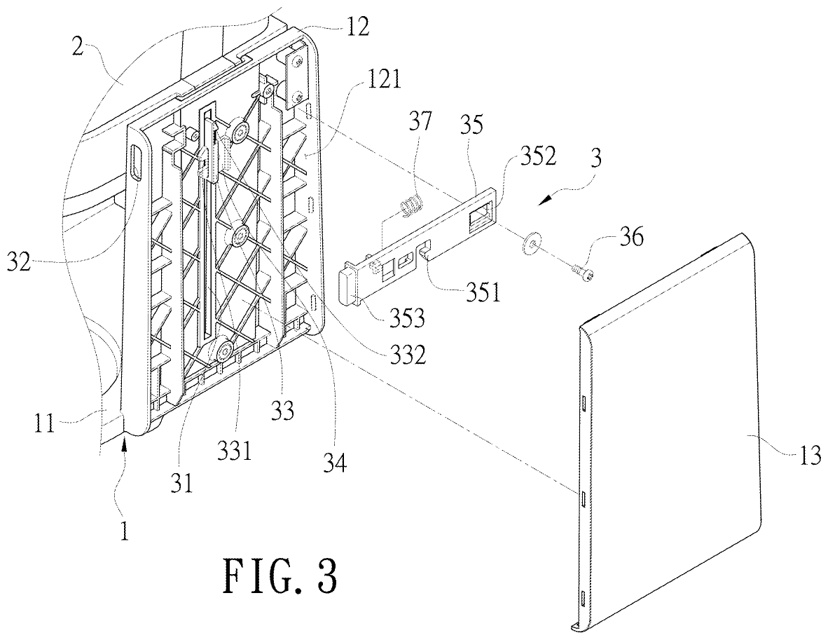

Also refer to FIG. 3, the lifting unit 3 is composed of a vertical guiding slot 31 formed on an inner surface of the respective support units 12 of the machine body 1 and communicating with the cavity 121 of the support unit 12, a through hole 32 arranged at a front side of one of the support units 12 and communicating with the cavity 121 of the support unit 12, a guiding block 33 which is formed on both a right side and a left side of the food processing unit 2, inserted through and projecting from the vertical guiding slot 31 on the support unit 12 correspondingly, two stopping blocks 34, and an operation bar 35. Each of the guiding blocks 33 is provided with a fixing hole 331 located in the cavity 121 of the respective support units 12 and the respective stopping blocks 34 are inserted into and connected with the fixing holes 331 of the respective guiding blocks 33 correspondingly to be abutting against a wall of the cavity 121 of the respective support units 12 for positioning and preventing the guiding block 33 from falling out of the guiding slot 31. As to the operation bar 35, it is mounted into the cavity 121 of one of the support units 12 by being inserted through the through hole 32 on the front side of one of the support units 12 of the machine body 1. The operation bar 35 is provided with a tenon 351, at least one horizontal guiding groove 352 and a driving portion 353. The tenon 351 is corresponding to the guiding block 33 on one of the support units 12 while the guiding block 33 is provided with a locking slot 332. Thereby the tenon 351 of the operation bar 35 is locked and connected with the locking slot 332 correspondingly. The lifting unit 3 further includes a positioning pin 36 and an elastic member 37. The positioning pin 36 is inserted into one of the support units 12 through the horizontal guiding groove 352 of the operation bar 35 correspondingly. The elastic member 37 is disposed between the operation bar 35 and one of the support units 12. The driving portion 353 is located at a front end of the operation bar 35 and projecting from and exposed outside the through hole 32 of one of the support units 12 after the operation bar 35 being inserted through the through hole 32.

While in use, a container such as a cup or a bowl is set and positioned on the container positioning portion 111 of the base 11 of the machine body 1 and then food materials which need to be processed is placed into the food processing unit 2 for being processed. After completion of the food processing, the food materials processed are dropped into the container under the food processing unit 2 accurately.

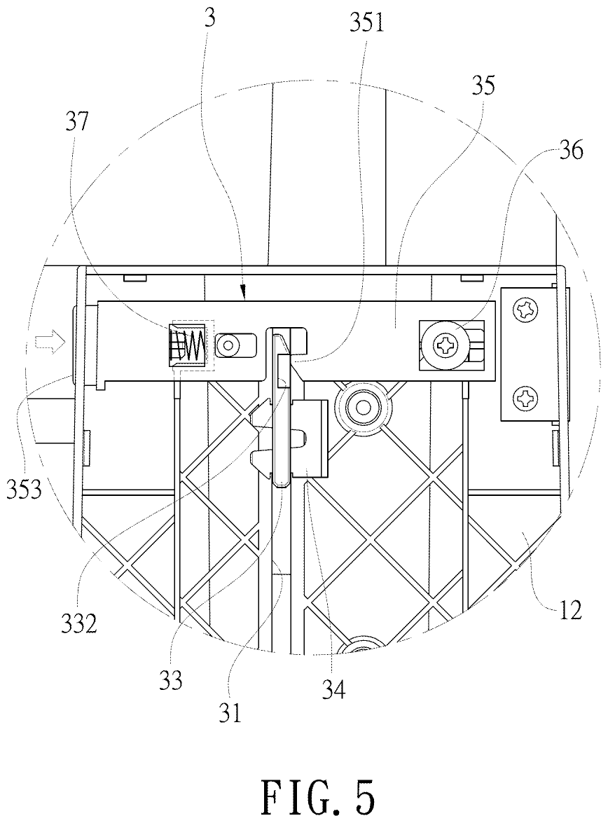

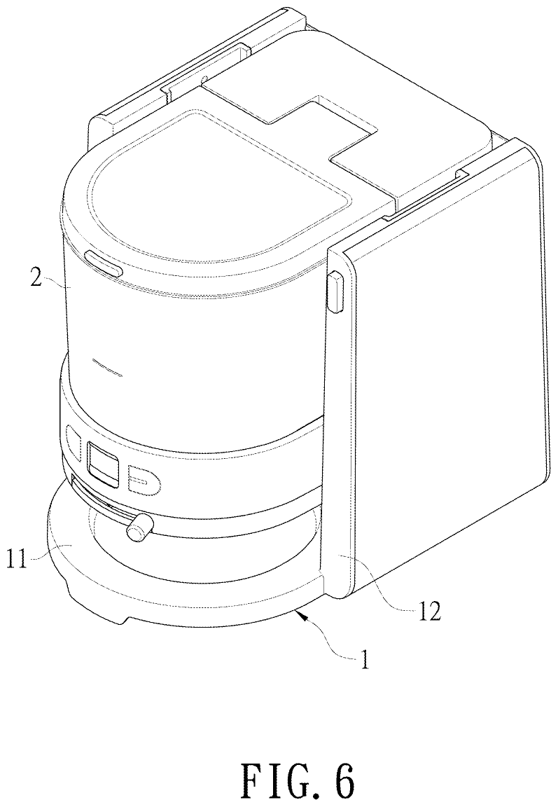

When users intend to save storage space, or manufacturers need to reduce packing volume, they can hold the food processing unit 2 with one hand and use the other hand to press the driving portion 353 which is located at the operation bar 35 of the lifting unit 3 and exposed outside the through hole 32 of one of the support units 12 for pushing the operation bar 35 to move one stroke horizontally. As shown in FIG. 5, now the tenon 351 of the operation bar 35 is separated from the locking slot 332 of the guiding blocks 33 on one side of the food processing unit 2 and released from the locked state. Then the food processing unit 2 is naturally dropped down and positioned at the base 11 due to gravity. Therefore, the food processing unit 2 is completely mounted and stored in space formed between the base 11 of the machine body 1 and the two support units 12 (as shown in FIG. 6).

Thereby the volume of the present food processor is significantly reduced. The packing and transportation costs are further saved efficiently. The lifting unit 3 is provided with the guiding slot 31 formed on the support unit 12 of the machine body 1 and the guiding block 33 formed on the food processing unit 2 for being inserted through the guiding slot 31 of the support unit 12. By the simple design of the tenon 351 of the operation bar 35 locked and connected with the locking slot 332 of the guiding blocks 33 on the food processing unit 2, the food processing unit 2 is able to be adjusted and positioned vertically. Thereby the production cost of the present food processor is significantly reduced.

In summary, the present food processor has the following advantages.
1. In the present food processor, the food processing unit and the machine body are connected by a lifting unit. While not in use, the food processing unit is moved downward into the machine body. Thus the volume of the food processor is significantly reduced and both packing and transportation costs are further saved efficiently.
2. The lifting unit of the present food processor is provided with a guiding slot formed on the support unit while the food processing unit includes a guiding block inserted through the guiding slot correspondingly. The lifting unit further includes an operation bar locked and connected with the guiding block. Thereby the food processing unit is moved and positioned vertically by such simple and easy design and the production cost of the food processor is further reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A food processor comprising:
a machine body which includes a base and two support units connected to two sides of the base and each of which is provided with a cavity;
a food processing unit which is mounted between the two support units of the machine body and located above the base of the machine body; and
a lifting unit which is provided with a vertical guiding slot formed on an inner surface of each of the support units of the machine body and communicating with the cavity of the support unit, a through hole arranged at a front side of one of the support units and communicating with the cavity of the support unit, a guiding block formed on each of two sides of the food processing unit, inserted through the vertical guiding slot of the support unit correspondingly and having a fixing hole located in the cavity of the respective support units, two stopping blocks each of which is inserted into and connected with the fixing hole of the guiding block correspondingly to be abutting against a wall of the cavity of the support unit, and an operation bar which includes a tenon corresponding to the guiding block of one of the support units and a driving portion formed on a front end of the operation bar; the guiding block of the support unit is provided with a locking slot for being locked and connected with the tenon of the operation bar correspondingly while the driving portion is projecting from and exposed outside the through hole of one of the support units after the operation bar being inserted through the through hole; the operation bar is mounted into the cavity of one of the support units by being inserted through the through hole of one of the support units of the machine body.

2. The food processor as claimed in claim 1, wherein an elastic member is disposed between the operation bar and one of the support units.

3. The food processor as claimed in claim 1, wherein the operation bar of the lifting unit is provided with at least one horizontal guiding groove and a positioning pin is inserted into one of the support units through the horizontal guiding groove of the operation bar correspondingly.

4. The food processor as claimed in claim 1, wherein the machine body is provided with two side covers each of which is used for covering the cavity of the support unit correspondingly.

5. The food processor as claimed in claim 1, wherein a container positioning portion is arranged at the base of the machine body.

6. The food processor as claimed in claim 5, wherein the container positioning portion at the base of the machine body is a recess.

7. The food processor as claimed in claim 1, wherein the food processing unit is selected from the group consisting of a food grinder, a coffee maker, a blender, and a shaved ice machine.
